(19) United States
(12) Patent Application Publication
(10) Pub. No.: US 2024/0202660 A1
(43) Pub. Date: Jun. 20, 2024

(54) PRODUCTION MANAGEMENT SYSTEM AND NON-TRANSITORY STORAGE MEDIUM STORING PRODUCTION MANAGEMENT PROGRAM

(71) Applicant: ANRITSU CORPORATION, Kanagawa (JP)

(72) Inventors: Jyunki KAWAMATA, Kanagawa (JP); Koji KOIZUMI, Kanagawa (JP); Hiroshi FUKUSHIMA, Kanagawa (JP); Kanto AMAMOTO, Kanagawa (JP)

(21) Appl. No.: 18/523,088

(22) Filed: Nov. 29, 2023

(30) Foreign Application Priority Data
Dec. 20, 2022 (JP) 2022-202856

(51) Int. Cl. G06Q 10/087

(52) U.S. Cl. CPC G06Q 10/087

(57) ABSTRACT

A production management system includes a server device and production line devices that are a weighing scale, a filling machine, a packaging machine, a printing machine, a printing inspection machine, an appearance inspection machine, a weight sorting machine, a metal detector, an X-ray inspection machine, and a caser. Each production line device and the server device are configured to communicate via a network. Each production line device transmits event data regarding a running status and an abnormal state to the server device. The server device displays the running status and the abnormal state of each production line device in a chronological order based on the received event data, and displays the display which is displayed in the chronological order for each production line device, in a direction intersecting a direction along the chronological order, in an order of arranging the production line devices on the production line.

### TECHNICAL FIELD

The present invention relates to a production management system that manages a production status on a production line for producing, for example, meat, fish, processed foods, pharmaceuticals, and the like.

### BACKGROUND ART

In a production line for producing, for example, meat, fish, processed foods, pharmaceuticals, and the like, the manufactured commodities are weighed, packaged at a predetermined weight, inspected for the presence of foreign matters, and finally inspected for the weight. The commodities determined to be non-defective by the above inspections are packed in boxes and shipped as final products.

Patent Document 1 discloses that, in a production management system that manages a plurality of production lines, a production-scheduled line indicating the production-scheduled quantity of a production plan, a scheduled-end line indicating the scheduled end time point of the production plan, and a production plan line indicating the production quantity at each time point of the production plan, a current time-point line indicating the collection time point of data being displayed, a current production line indicating the production quantity at the collection time point of the data being displayed, a production performance line indicating the production quantity at each time point until the collection time point of the data being displayed, and a production-predicted line indicating the production quantity at each time point when production continues in the current state are displayed for each production line.

With such a display, it is possible to easily identify a production line in which production will be delayed when the production continues in the current state. In addition, from a difference between the production quantity of the production plan line and the production quantity of the production-predicted line on the scheduled-end line in the production line in which the production is delayed, it is possible to know the production quantity predicted to fall short of a production-scheduled quantity, and it is possible to easily perform adjustment such as distribution of the production quantity predicted to fall short of the production-scheduled quantity into another production line having extra production quantity.

### RELATED ART DOCUMENT

### Patent Document

[Patent Document 1] JP-A-2019-212234

### DISCLOSURE OF THE INVENTION

### Problem that the Invention is to Solve

However, although, with such a display, it is possible to easily identify a production line where production is delayed, it is not possible to easily determine the cause of the production delay. In particular, production lines for foods, pharmaceutical, and the like are divided into a plurality of processes and interconnected from a view of quality management, and thus it is difficult to ascertain the cause of a production delay for the entire production line.

Therefore, an object of the present invention is to provide a production management system capable of displaying a state of each device on a production line configured by a plurality of devices and easily determining a cause of an error occurring on the production line.

### Means for Solving the Problem

According to a first aspect of the present invention, a production management system manages a production line including two or more production line devices. The system includes a server device configured to be able to communicate with the production line devices. The production line device transmits event data including a running status and information regarding an abnormal state to the server device, the event data being set in advance. The server device displays the running status and the abnormal state of each of the production line devices in a chronological order based on the received event data, and displays the display which is displayed in the chronological order for each of the production line devices, in a direction intersecting a direction along the chronological order, in an order of arranging the production line devices on the production line.

With this configuration, the running status and the abnormal state of each production line device on the production line are displayed in the chronological order by arranging the production line devices in an order of a flow of products on the production line. Therefore, it is possible to check the running status and the abnormal state of each production line device in a list, and to easily determine a cause of an error occurring on the production line.

Further, according to a second aspect of the present invention, in the production management system in the first aspect, the server device further displays an occurrence status of a product defect in addition to the running status and the abnormal state.

With this configuration, the occurrence status of the product defect is displayed in addition to the running status and the abnormal state. Therefore, it is possible to check the running status and the abnormal state together with the occurrence of the product defect in a list, and to easily determine the cause of the product defect.

Further, according to a third aspect of the present invention, in the production management system in the first aspect, the production management system further includes an image capturing unit that captures an image of a vicinity of the production line devices and transmits the captured image to the server device. The server device stores the image obtained by capturing the vicinity of the production line devices, cuts out an image of one of the production line devices as a transmission source for a predetermined acquisition time before and after an event occurrence time point, when receiving the event data set in advance, and stores the cut-out image in association with the received event data.

With this configuration, when the event data set in advance is received, the image of the production line device as the transmission source is cut out for the predetermined acquisition time before and after the event occurrence time point, and is stored in association with the received event data. Therefore, it is possible to check images of the production line device when an abnormality has occurred or a product defect has occurred, and to easily determine the cause of an error occurring on the production line.

Further, according to a fourth aspect of the present invention, in the production management system in the second aspect, the production management system further includes an image capturing unit that captures an image of a vicinity of the production line devices and transmits the captured image to the server device. The server device stores the image obtained by capturing the vicinity of the production line devices, cuts out an image of one of the production line devices as a transmission source for a predetermined acquisition time before and after an event occurrence time point, when receiving the event data set in advance, and stores the cut-out image in association with the received event data.

With this configuration, when the event data set in advance is received, the image of the production line device as the transmission source is cut out for the predetermined acquisition time before and after the event occurrence time point, and is stored in association with the received event data. Therefore, it is possible to check images of the production line device when an abnormality has occurred or a product defect has occurred, and to easily determine the cause of an error occurring on the production line.

Further, according to a fifth aspect of the present invention, in the production management system in the third aspect, the server device further displays presence or absence of the image of the production line devices in addition to the running status and the abnormal state.

With this configuration, the presence or absence of the image of the production line device is displayed in addition to the running status and the abnormal state. Therefore, it is possible to easily check whether there is an image related to an error occurring on the production line, and, when there is the image, it is possible to check the image and easily determine the cause of the error occurring on the production line.

Further, according to a sixth aspect of the present invention, in the production management system in the fourth aspect, the server device further displays presence or absence of the image of the production line devices in addition to the running status and the abnormal state.

With this configuration, the presence or absence of the image of the production line device is displayed in addition to the running status and the abnormal state. Therefore, it is possible to easily check whether there is an image related to an error occurring on the production line, and, when there is the image, it is possible to check the image and easily determine the cause of the error occurring on the production line.

Further, according to a seventh aspect of the present invention, there is provided a non-transitory storage medium storing a production management program of a production management system that including a production line including two or more production line devices and a server device configured to be able to communicate with the production line devices, in which the production line device transmits event data set in advance to the server device, the event data being information regarding a running status and an abnormal state. The production management program causes the server device to realize a function of displaying the running status and the abnormal state of each of the production line devices in a chronological order based on the received event data, and displaying the display which is displayed in the chronological order for each of the production line devices, in a direction intersecting a direction along the chronological order, in an order of arranging the production line devices on the production line.

With this configuration, the running status and the abnormal state of each production line device on the production line are displayed in the chronological order by arranging the production line devices in an order of a flow of products on the production line. Therefore, it is possible to check the running status and the abnormal state of each production line device in a list, and to easily determine a cause of an error occurring on the production line.

Further, according to an eighth aspect of the present invention, in the non-transitory storage medium storing the production management program in the seventh aspect, the server device further displays an occurrence status of a product defect in addition to the running status and the abnormal state.

With this configuration, the occurrence status of the product defect is displayed in addition to the running status and the abnormal state. Therefore, it is possible to check the running status and the abnormal state together with the occurrence of the product defect in a list, and to easily determine the cause of the product defect.

Further, according to a ninth aspect of the present invention, in the non-transitory storage medium storing the production management program in the seventh aspect, the production management system further includes an image capturing unit that captures an image of a vicinity of the production line devices and transmits the captured image to the server device. The server device stores the image obtained by capturing the vicinity of the production line devices, cuts out an image of one of the production line devices as a transmission source for a predetermined acquisition time before and after an event occurrence time point, when receiving the event data set in advance, and stores the cut-out image in association with the received event data. The server device further displays presence or absence of the image of the production line devices in addition to the running status and the abnormal state.

With this configuration, the presence or absence of the image of the production line device is displayed in addition to the running status and the abnormal state. Therefore, it is possible to easily check whether there is an image related to an error occurring on the production line, and, when there is the image, it is possible to check the image and easily determine the cause of the error occurring on the production line.

### Advantage of the Invention

According to the present invention, it is possible to provide a production management system capable of easily determining a cause of an error occurring on a production line.

### BRIEF DESCRIPTION OF THE DRAWINGS

FIG. 1 is a schematic configuration diagram of a production management system according to an embodiment of the present invention.

FIG. 2 is a diagram illustrating a display example of a device state of the production management system according to the embodiment of the present invention.

### BEST MODE FOR CARRYING OUT THE INVENTION

Hereinafter, a production management system according to an embodiment of the present invention will be described in detail with reference to the drawings.

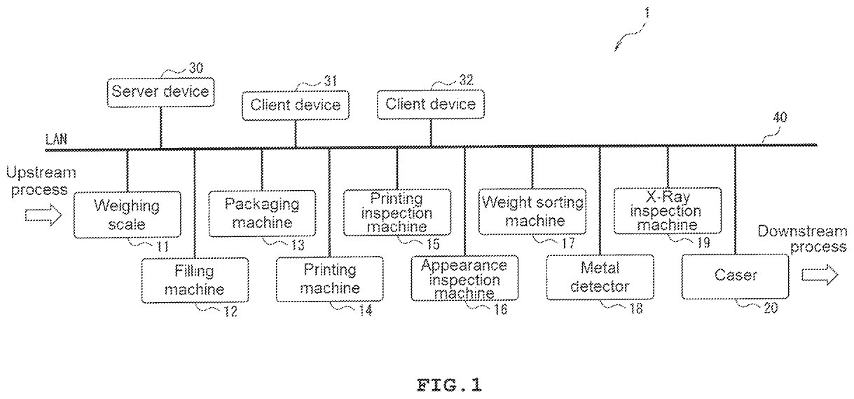

In FIG. 1, a production management system 1 according to an embodiment of the present invention manages a production line of receiving raw materials such as foods and drinks manufactured and processed in an upstream manufacturing process, packaging the raw materials together in a predetermined weight in a weighing process and a packaging process to obtain a product, inspecting the weight of the product, the presence of foreign matters, a packaging state, and the like in an inspection process, and boxing a product having an inspection result of being determined to be non-defective in a boxing process.

The production line is configured to include a weighing scale 11, a filling machine 12, a packaging machine 13, a printing machine 14, a printing inspection machine 15, an appearance inspection machine 16, a weight sorting machine 17, a metal detector 18, an X-ray inspection machine 19, and a caser 20. Each of the devices (11, 12, 13, 14, 15, 16, 17, 18, 19, and 20) is also referred to as a production line device. Usually, the devices (11, 12, 13, 14, 15, 16, 17, 18, 19, and 20) have a form of being arranged and lined up in a series. Transport means such as a belt conveyor is disposed between the preceding and following processes in the production line and between the devices in each process.

The present embodiment is not limited to a case where the devices (11, 12, 13, 14, 15, 16, 17, 18, 19, and 20) are arranged to be adjacent to each other as illustrated in FIG. 1. For example, there may be provided a case where the devices from the weighing scale 11 to the packaging machine 13 are arranged to be adjacent to each other in a raw material area for handling the raw material before packaging, the devices from the appearance inspection machine 16 to the caser 20 are arranged to be adjacent to each other in a product area for handling a packaged product, and the divided both areas are joined to each other by transport means including a belt conveyor or a chute.

Regarding the devices (11, 12, 13, 14, 15, 16, 17, 18, 19, 20) constituting such a production line, the devices having different functions are variously combined in accordance with the raw materials to be handled, the packaging format thereof, the inspection content for a packaged product, handling of a product inspected to be defective, and a packing form of a product inspected to be non-defective.

When the entirety of the devices constituting the production line are referred to without specifying the devices, the devices may be written as “each device (11 to 20)”.

First, an operation related to product production among operations of each device (11 to 20) will be described from the upstream to the downstream of the production line, in order of a weighing/packaging process, an inspection process, and a boxing process. This is merely an example of one typical form and the modified form thereof.

The weighing/packaging process is configured by a weighing/packaging device exemplified as the weighing scale 11, the filling machine 12, the packaging machine 13, and the printing machine 14. In the weighing/packaging process, the weighed and packaged product is discharged to the inspection process.

The weighing scale 11 receives raw materials manufactured in the upstream manufacturing process, collects or combines the raw materials in predetermined amounts, and supplies the collected or combined raw materials to the filling machine 12. The supply to the filling machine 12 is performed in response to a request signal output from the filling machine 12.

In addition, the weighing scale 11 is configured to output a warning signal, for example, when the raw materials are insufficiently supplied, and thus the weighing scale 11 to supply the raw materials to the filling machine 12 turns into a standby state. At this time, even though the weighing scale 11 is in operation, the weighing scale 11 is in the standby state due to the insufficient supply of the raw materials. This standby state is released when the raw materials are sufficiently supplied.

The filling machine 12 discharges the raw material supplied from the weighing scale 11 to the packaging machine 13 at a predetermined timing. Specifically, the raw material supplied from the weighing scale 11 is temporarily stored, and is discharged in response to a request signal output from the packaging machine 13. Thereafter, a request signal for requesting the supply of the raw material is output to the weighing scale 11.

Further, the filling machine 12 is configured to output a warning signal when there is no supply of the raw materials even though the filling machine 12 outputs a request signal to the weighing scale 11. At this time, even though the filling machine 12 is in operation, the filling machine 12 turns into the standby state waiting the supply of the raw materials. This standby state is released when the raw material is supplied.

The packaging machine 13 packages a predetermined weight of raw materials discharged from the filling machine 12 with a packaging material and discharges the result of the packaging to the printing machine 14. Generally, a bag is formed by cutting a long film wound in a roll into a predetermined length and heat-sealing the end portions.

If the packaging machine 13 uses up the set packaging material, the packaging machine 13 turns into the standby state until a new packaging material is set. During this period, no request signal is output to the filling machine 12.

Further, the packaging machine 13 is configured to output a warning signal when there is a no supply of the raw materials even though the packaging machine 13 outputs a request signal to the filling machine 12. At this time, even though the packaging machine 13 is in operation, the packaging machine 13 turns into the standby state waiting the supply of the raw materials. This standby state is released when the raw material is supplied.

The weighing scale 11, the filling machine 12, and the packaging machine 13 described above may be appropriately selected to constitute the weighing/packaging process in accordance with the type of raw material to be handled and the form of a product to be produced. That is, the weighing scale 11, the filling machine 12, and the packaging machine 13 are merely examples of one form of the device, and only need to include a configuration of receiving the raw materials from the upstream manufacturing process and producing a packaged product. For example, in a production line in which foods (sweet bread, instant bag noodles, and the like) molded and processed in the upstream manufacturing process are packaged one piece or two pieces at a time, there is no need to use the weighing scale 11 or the filling machine 12, and it is sufficient that the raw materials can be fed to the packaging machine 13 at regular intervals by the transport means.

The printing machine 14 prints identification information for identifying each product, such as a barcode, a two-dimensional code, and a serial number, on the packaged product discharged from the packaging machine 13 and discharges the result of the printing to the printing inspection machine 15. Printing here may mean, for example, that identification information is directly printed at a predetermined position such as the side surface or the bottom surface of a packaged product, or that a label with identification information printed on the label is pasted. The printing form (color and size of printing) may be appropriately set in accordance with the shape of the product and the design of the packaging, in a range that provides the required readability.

Further, the printing machine 14 is configured to output a warning signal when the remaining amount of ink, ink ribbon, or label for printing becomes low or runs out.

The inspection process is configured by inspection device such as the printing inspection machine 15, the appearance inspection machine 16, the weight sorting machine 17, the metal detector 18, and the X-ray inspection machine 19. In the inspection process, products sequentially discharged from the weighing/packaging process are received and inspected, and a product that is a defective product as an inspection result is rejected from the production line by a rejection device (to be described later), and other products (non-defective products) are discharged to the boxing process.

The rejection device that rejects a product from the production line may be provided in each inspection device depending on how to handle a product inspected to be defective on the production line. When two or more groups are formed by the adjacent inspection devices, the rejection device may be provided in each group. Alternatively, the rejection device may be provided at the end of the inspection process.

The rejection device operates based on a rejection signal that is output for a defective product by the inspection device located immediately before the rejection device is provided. As described above, the present embodiment is not limited thereto. For example, when two adjacent inspection devices include a common rejection device, the upstream inspection device outputs a signal representing the inspection result to the downstream inspection device. The downstream inspection device operates the common rejection device based on the signal received from the upstream inspection device and the inspection result of the downstream inspection device, and rejects a defective product from the production line.

The printing inspection machine 15 performs a reading inspection on the identification information printed by the printing machine 14 on the packaged product discharged from the printing machine 14. The printing inspection machine 15 determines the packaged product with no defect in printing when the identification information is correctly read, to be a non-defective product and discharges this product to the appearance inspection machine 16. The reading inspection may include a comparison inspection in the printed identification information is received from the printing machine 14 and the received identification information is compared with the read information.

The printing machine 14 and the printing inspection machine 15 may be configured as a part of the packaging machine 13. In this case, in a boundary between the weighing/packaging process and the inspection process described above, the packaging machine 13 may functionally straddle both processes.

The appearance inspection machine 16 inspects the appearance of the packaged product discharged from the printing inspection machine 15 based on an image captured by a camera, and the like, determines the packaged product with no defect in the inspection to be a non-defective product, and discharges the non-defective product to the weight sorting machine 17.

Specifically, the appearance inspection machine 16 inspects the packaged product for discoloration or deformation, and the packaging for scratches, tears, or stains. For example, a known image processing filter is applied to an image captured by a camera, and, when features matching with conditions determined in advance are extracted, the product of this image is determined to be defective. A stable inspection may be performed by changing illumination conditions such as the wavelength and intensity of emitted light depending on the type of packaging material and the content of the inspection, or by using a plurality of cameras.

The weight sorting machine 17 inspects the weight of the packaged product discharged from the appearance inspection machine 16, determines the packaged products with no defect in the inspection to be a non-defective product, and discharges the non-defective product to the metal detector 18.

For example, the weight sorting machine 17 includes weighing means for weighing a product as an inspection target while transporting the product by a weighing conveyor and determination means for determining whether or not the weighed value representing the weighing result of the weighing means is within a non-defective product range defined by upper and lower limit values. If the weighed value is within the non-defective product range, the product is determined to be a product with a correct quantity and no defect. A defective (defective weight) product that is outside the non-defective product range includes an overweight product when the weighed value exceeds the upper limit value, a lightweight product when the weighed value falls below the lower limit value, and a weighing-impossible product (weighing error) when it is not possible to perform weighing correctly.

The metal detector 18 performs an inspection of whether or not any metal is mixed in the packaged product discharged from the weight sorting machine 17 on this packaged product. The metal detector 18 determines the packaged product with no defect in the inspection to be a non-defective product and discharges this packaged product to the X-ray inspection machine 19.

For example, the metal detector 18 generates a predetermined magnetic field in an inspection area, and inspects whether metal is contained or not in the product as an inspection target, based on the fluctuation of the magnetic field caused by passing the product as the inspection target. If the amount of fluctuation in the magnetic field is within a non-defective product range, this product is determined to be a normal product with no defects. A metal object that should not exist is present in a defective product for which the amount of fluctuation in the magnetic field is outside the non-defective product range. It is also possible to inspect whether a metal object that should be enclosed is present in the packaged product, and in this case, a product without a metal object is determined to be a defective product.

The X-ray inspection machine 19 inspects whether or not there is a defect in the packaged product discharged from the metal detector 18 or a foreign matter is contained in the packaged product. The X-ray inspection machine 19 determines the packaged product with no defect in inspection to be a non-defective product and discharges this packaged product to the caser 20.

For example, the X-ray inspection machine 19 emits X-rays from an X-ray generator, detects the X-rays transmitted through the product as the inspection target with an X-ray detector, generates a transmission image, and inspects whether or not there is a defect in the product or a foreign matter is contained in this product, by image processing. When the packaged product is used as the inspection target, examples of defects that can be inspected in addition to the presence or absence of a foreign matter include excessive or insufficient amount of contents, packaging defects such as contents jamming into the packaging material, and defects in shape such as cracks and chips.

The appearance inspection machine 16, weight sorting machine 17, metal detector 18, and X-ray inspection machine 19 described above are appropriately selected in accordance with the type of raw material to be handled and the form of a product to be produced, and the order is not limited to this. For example, the inspection process may be configured by the appearance inspection machine 16, the X-ray inspection machine 19, the metal detector 18, and the weight sorting machine 17 in this order. Further, the present embodiment is not necessarily limited to a form of inspecting a packaged product, and may also inspect the raw material before being packaged. Thus, a loss is reduced as compared to a case of discarding a product that is inspected to be defective after packaged.

The boxing process is configured by the caser 20. In the boxing process, the products sequentially discharged from the inspection process, that is, the products determined to be non-defective in the inspection process, are received and are packed into boxes in accordance with predetermined boxing conditions.

The caser 20 packs the packaged product discharged from the X-ray inspection machine 19 into a box, and then seals and discharges the packaged product to a downstream process. “Boxing” here refers to a predetermined number of packaged products being bundled together and wrapped with an exterior material to protect the packaged products from an external environment. The boxing condition is appropriately selected in accordance with the type of packaged product and handling in the post-process.

Next, the server device 30 and client devices 31 and 32 to which each device (11 to 20) is connected via a computer network (network 40) will be described.

The server device 30 is configured to include computer units including a central processing unit (CPU), a random access memory (RAM), a read only memory (ROM), a hard disk drive, and an input/output port (not illustrated).

Each of the client devices 31 and 32 is configured by a computer unit including a CPU, a RAM, a ROM, a hard disk drive, and an input/output port (not illustrated).

The weighing scale 11, the filling machine 12, the packaging machine 13, the printing machine 14, the printing inspection machine 15, the appearance inspection machine 16, the weight sorting machine 17, the metal detector 18, the X-ray inspection machine 19, the caser 20, the server device 30, and the client devices 31 and 32 are able to communicate with each other via the network 40.

The arrangement of each device on the production line is set in advance in the server device 30. Information regarding other devices arranged in front and rear of one device is stored in association with, for example, an ID unique to the device.

The server device 30 receives, via the network 40, event data such as the inspection result, the running status, and the abnormal state transmitted from each device on the production line, stores the event data in a hard disk drive, and manages the event data. The event data includes information of a time point when an event of the event data has occurred.

As the running status, for example, operating, running, and stopped are transmitted. Operating is a state in which the device can be operated but no product is flowing. Running is a state in which the device is in a state where the device can be operated and the product is flowing. Stopped is a state where the device cannot be operated, such as a case where the belt conveyor is stopped or the power is not turned on. The running status is not limited to the categories such as “operating”, “running”, and “stopped” for each device, and other statuses may be defined and used on the server device 30 side.

As the abnormal state, for example, an abnormality and a warning are transmitted. The abnormality indicates that a major problem has occurred in the device and the device cannot be operated. The warning indicates that a minor problem has occurred with the device, but the device can be operated. The abnormal state is not limited to “abnormality” and “warning”, and other states may be defined and used. In other words, for the event data transmitted from each device, it is sufficient that the state is classified based on an event definition file defined by the setting of the server device 30, and this makes it possible to efficiently ascertain the running status of the production line in accordance with the magnitude of the influence on the production line and the like. By updating this event definition file and applying a new definition, it is possible to effectively utilize the event data already stored in the server device 30 to analyze the cause of a production delay on the production line.

Generally, event data indicating “abnormality” or “warning” is output as data indicating that an abnormality or warning has occurred in the device and the occurrence time point of the abnormality or warning, and, in many cases, the event data is not output as data indicating that the abnormality or warning has been resolved. In such a case, it is possible to indirectly estimate, from another event data, that the abnormality or warning has been resolved. For example, it may be determined that the abnormality or warning has been resolved when the running status is changed from “stopped” or “operating” to “running” after the abnormality or warning has occurred.

A device ID unique to the device is assigned to the event data, and the ID may be used as identification information for identifying which event data has been transmitted from which device on the data. Furthermore, the assignment of the device ID unique to the device may be added in the device that transmits the event data, or may be added in the server device 30 that receives the event data. As a result, even if there is a device that transmits the event data to which a device ID unique to the device is not added, it is possible to analyze the cause of a production delay on the production line.

Here, the event data transmitted from each device (11 to 20) to the server device 30 will be described.

The weighing scale 11 transmits information indicating the amount of the discharged raw material to the server device 30 every time a predetermined amount of the raw material is discharged in response to receiving a request signal from the filling machine 12. Furthermore, for example, the weighing scale 11 outputs a warning signal indicating the shortage of the raw material when the raw material is insufficient and then the weighing scale 11 turns into the standby state of pausing the discharge of the raw material to the filling machine 12, and transmits the warning signal to the server device 30.

The filling machine 12 outputs a discharge signal when discharging the raw material to the packaging machine 13, and transmits the discharge signal to the server device 30. Furthermore, for example, the filling machine 12 outputs a warning signal indicating that there is no supply of the raw material even though the filling machine 12 outputs a request signal to the weighing scale 11, and transmits the warning signal to the server device 30.

The packaging machine 13 outputs information indicating that packaging has been successfully completed and transmits the information to the server device 30. In addition, the packaging machine 13 transmits a warning signal to the server device 30, for example, when the packaging machine 13 turns into the standby state while exchanging a packaging material, or when the supply of the raw material from the filling machine 12 is interrupted for more than a predetermined time.

The printing machine 14 outputs a warning signal indicating that the remaining amount of ink is low and transmits the warning signal to the server device 30.

Each device (the printing inspection machine 15, the appearance inspection machine 16, the weight sorting machine 17, the metal detector 18, and the X-ray inspection machine 19) in the inspection process transmits the inspection result to the server device 30. Furthermore, when defective products that cannot be inspected correctly has consecutively occurred, the warning signal indicating the details of each defective product is transmitted to the server device 30.

Further, when it is detected that the rejection device cannot correctly reject a product with a defective inspection result, a warning signal indicating that rejecting the defective product has failed is displayed and transmitted to the server device 30.

The caser 20 displays a warning signal, for example, indicating that a predetermined number of products are not delivered at a predetermined timing, or that the packaging material is insufficient, and transmits the warning signal to the server device 30.

In addition to the warning signals described above, signals indicating the respective states when the power is turned on and the device turns into a state of waiting for a manipulation, when a manipulator performs an operation start manipulation, and when an operation stop manipulation is performed are transmitted to the server device 30. For example, each device (11 to 20) transmits a level signal that is at a high (H) level when the power is turned on, and is at a low (L) level when the power is turned off. A similar level signal can be applied to the operation start and stop manipulations.

Furthermore, upon receiving the event data transmitted from each device, the server device 30 may add time-point information when the event data has been received, as a timestamp. As a result, even when the event data of any device does not include the time-point information, time-point information at approximately the same time point when the device has transmitted the event data is recorded in the server device 30, and it is possible to avoid a functional restriction of control software on the device side. Furthermore, it is not necessary to strictly synchronize the time point set on each device, and even if there is a difference of several seconds to several minutes, the influence is small. When the server device 30 receives an analog level signal from each device, a data transmission unit including an analog signal input port may be provided near each device, and the server device 30 may be able to receive the data from the data transmission unit via the network 40.

Further, upon receiving the event data transmitted from each device, the server device 30 sequentially stores the event data as a text file in a storage area associated with the device ID, for each device that has transmitted the event data. Alternatively, pieces of the event data are sequentially added as records to a data table associated with the device ID. The present embodiment is not limited thereto, and the form of storing the event data may be selected as appropriate.

A camera that continuously captures moving images or still images of the operation of each device and the processing status of the raw material or the packaged product in each device is provided near each device, and an image obtained by capturing each device is transmitted to the server device 30 together with information indicating an image capturing time point. The camera does not need to be provided in each device, and the camera may be installed to capture images of a plurality of devices.

For example, the server device 30 constantly stores videos obtained by capturing each device for a period from the current time point up to a predetermined accumulation time. When specific event data set in advance is received, for example, when an abnormality is transmitted as the abnormal state of event data or when a defect is transmitted as the inspection result of the event data, the image of the device as a transmission source is cut out for a predetermined acquisition time before and after an occurrence time point of an event, and the cut-out image is stored in association with the received event data. The server device 30 may store all images obtained by capturing each device. In this case, the specific event data set in advance only needs to be associated with the occurrence time point of the corresponding event, and the event data may include information indicating the length of the cut-out image.

At a predetermined timing, for example, after a production lot of a certain product is finished or after production for a day is finished, the server device 30 displays the running status of the day on a display device provided in the client devices 31 and 32 based on the received event data. Furthermore, the running status may be updated at a cycle or time point set in accordance with the production line management procedure, or the latest running status may be displayed in response to manipulations from the client devices 31 and 32.

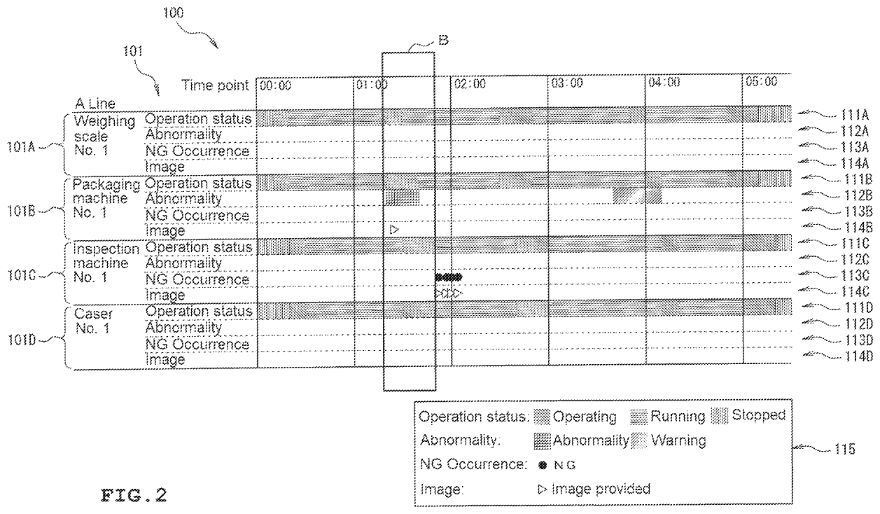

For example, as illustrated in FIG. 2, the server device 30 displays display data 100 such as the running status of the selected device, the abnormal state, an occurrence status of a defect, and the presence or absence of an image, on the display device in a predetermined display form, in chronological order.

In FIG. 2, the running status of each device is displayed in a display area divided into strips on each device display portion 101. A running status display portion 111, an abnormal state display portion 112, a defect occurrence display portion 113, and an image presence/absence display portion 114 are displayed in the device display portion 101, respectively. Legend data 115 is an explanation of what marks and color coding in the display data 100 mean, and can be displayed or hidden as necessary.

In FIG. 2, the device display portion 101 is divided into device display portions 101A, 101B, 101C, and 101D, that are thick strips of the same height, extend along the time axis and are arranged vertically, and corresponding four device names and device IDs are displayed on the device display portions 101A, 101B, 101C, and 101D. Each of the device display portions 101A, 101B, 101C, and 101D is divided into thin strips of the same height. The running status display portion 111 (111A, 111B, 111C, and 111D), the abnormal state display portion 112 (112A, 112B, 112C, and 112D), the defect occurrence display portion 113 (113A, 113B, 113C, and 113D), and the image presence/absence display portion 114 (114A, 114B, 114C, and 114D) are arranged vertically in this order.

The display layout of each display portion (111, 112, 113, 114) in each device display portion 101 may be set as a common layout setting of the device display portion 101, in which the device ID of the device to be displayed, the type of event data, and the display form thereof are defined in advance. A layout setting may be made individually for each of the device display portions 101A, 101B, 101C, and 101D. In either case, the time point display is common to each display portion (111, 112, 113, 114) and displayed on the same time axis.

The device display portion 101 is displayed in the order of a flow of the production line, such that, for example, the device in the upstream process of the production line is on the top and the device in the downstream process is on the bottom.

In the running status display portion 111, the running status of the device is displayed in a visually distinguishable manner, for example, by shading or changing the color of the display area so that “operating”, “running”, and “stopped” being the running status of the event data indicates the time period of each running status.

In the abnormal state display portion 112, “abnormality” and “warning” of the abnormal states of the event data are displayed in a visually distinguishable manner, for example, by changing the shading or color of the corresponding display area so that the “abnormality” and “warning” of the abnormal states of the event data indicate the continuous time period of the respective states.

Further, the running status display portion 111 and the abnormal state display portion 112 are made be independent display areas in a form of strips having the same height, and are arranged vertically in two stages. As a result, it is possible to easily compare the running status and the abnormal state of the devices that operate in conjunction with each other on a common time axis.

In the defect occurrence display portion 113, when a defect is received as the inspection result of the event data, a mark (a black circle in the figure) is displayed at a position corresponding to the occurrence time point of the defect in the display area.

In the image presence/absence display portion 114, when there is image data associated with the event data, a mark (a triangle in the figure) is displayed at a position corresponding to the occurrence time point of the associated event data in the display area. When the mark is selected from the client device 31 or 32 with a manipulation unit such as a mouse or a keyboard, the server device 30 may associate the corresponding image data to reproduce image data.

In particular, the running status display portion 111 and the abnormal state display portion 112 are each made be independent display areas, separated by a boundary line, and arranged vertically. As a result, without one color-coded display overlapping with the other color-coded display, and without changing the display screen, it is possible to instantly ascertain the color-coded display in both display areas, and to compare the running statuses of the devices that operate in conjunction with each other, on a common time axis from two different viewpoints.

Furthermore, the defect occurrence display portion 113 and the image presence/absence display portion 114 each are made be independent display areas, separated by a boundary line, and are arranged vertically. As a result, without one mark overlapping with the other mark, and without changing the display screen, it is possible to instantly ascertain and manipulate the mark in both display areas. This makes it easy to perform selection by a mouse or touch manipulation when referring to an image when the defect has occurred is desired. Furthermore, the running status displayed by the running status display portion 111 and the abnormal state display portion 112 can also be compared on a common time axis.

The display layout for displaying the display data 100 on the display device in the display form as illustrated in FIG. 2 may be set on the server device 30 side or may be set in each of the client devices 31 and 32. Further, it is sufficient that the display layout can be temporarily changed in response to a manipulation from the client device 31 or 32. Furthermore, instead of the display form illustrated in FIG. 2, the time axis may be set in the vertical direction and the arrangement order of the devices may be set in the horizontal direction.

An example of a procedure for displaying the event data stored in the server device 30 on the display device in the display form as illustrated in FIG. 2 will be described. Here, regarding devices specified by four device IDs in the production line “A line”, a display layout in which device names of “weighing scale No. 1”, “packaging machine No. 1”, “inspection machine No. 1”, and “caser No. 1” corresponding to the process from upstream to downstream and the areas of “running status”, “abnormality”, “defect occurrence”, and “image” are defined will be described as an example. Normally, the horizontal axis is initially set to indicate a time point, and which time period is displayed can be manipulated as appropriate.

The server device 30 reads the stored event data from the storage area at a timing set in advance, and specifies the device ID of the device and the type of event data to be displayed on the device display portion 101 based on a display layout set in advance. Information indicating the corresponding event data and the time point when the event data is transmitted from the device or received by the server device 30 is specified.

The server device 30 specifies the time point corresponding to each event from the device name corresponding to the device ID and the event data specified by the device ID. Regarding the “running status”, the time period for “operating”, the time period for “running”, and the time period for “stopped” are specified from the time point when the running status is changed. Regarding “abnormality”, if there is event data classified as “abnormality”, the time period corresponding to the event is specified. Regarding “defect”, if there is event data classified as “defect”, the time point corresponding to the event is specified. Regarding “image”, if the image is stored, the recording time point of the image is specified.

Specifically, first, the server device 30 specifies the time periods “operating”, “running”, and “stopped” from the change time point of the running status specified from the event data as “running status” of “weighing scale No. 1” displayed on the top row based on the setting contents of the display layout. Similarly, for “abnormality”, the time period for the abnormality or warning is specified from the event data. Next, the time point is specified from the event data corresponding to “defect”. Similarly, for “ ”, if there is the stored image, the associated capturing time point is specified.

Similarly, for “packaging machine No. 1”, “inspection machine No. 1”, and “caser No. 1”, the corresponding time periods and time points are specified from the corresponding event data.

When the corresponding time period and time point of the device as a display target are specified from the event data, the server device 30 generates the display data 100 based on the display form as shown in the legend data 115.

Regarding the display data 100, a style portion that displays the device name, the item name, the time point, and the boundary line of the display area, which are set in advance, are displayed regardless of the device state, and a data portion that displays color coding and marks in accordance with the device state are separately generated. Both portions may be generated as integrated image data.

FIG. 2 illustrates the display data 100 that displays the device state of “A line” from time points 0:00 to 05:30. The cause of a production delay on the production line, which may be ascertained from the device state in a time period B corresponding to about the time points 01:20 to 01:50 will be described below.

The running statuses and abnormal states of four devices constituting “A line” are displayed in the device display portion 101 based on the order of the arrangement on the production line. That is, it can be understood that “weighing scale No. 1”, “packaging machine No. 1”, “inspection machine No. 1”, and “caser No. 1” are arranged in order from the upstream on this production line.

Focusing on the device display portion 101B of “packaging machine No. 1”, it can be understood that a period from about the time point 01:20 to about the time point 01:40 on the abnormal state display portion 112B is “abnormality”, and an image in which a mark is displayed is recorded at about the time point 1:20 on the image presence/absence display portion 114B. It can be understood that the running status display portion 111B also shows “operating” in the same time period, but, since a period until about the time point 01:20 is “running”, some abnormality has occurred at about the time point 01:20, and thus the packaging operation is stopped.

It is possible to ascertain that “weighing scale No. 1” is located upstream of “packaging machine No. 1”, and as “packaging machine No. 1” becomes “abnormality”, the state has changed from “running” to “operating” at about the time point 01:20. At this time, it can be understood that restoration work is performed in “packaging machine No. 1”, and, even though “weighing scale No. 1” runs from the about the time point 01:30, but the restoration work on “packaging machine No. 1” is continued until about the time point 01:40 and becomes “running”.

It can be understood that “inspection machine No. 1” and “caser No. 1” are arranged downstream of “packaging machine No. 1”, and the state has changed from “running” to “operating” at about the time point 01:30 during the restoration work of “packaging machine No. 1”.

As described above, it is possible to ascertain that the state in which the running status of each device is “operating” and the product is not flowing is caused by the abnormal state of “packaging machine No. 1”.

In addition, the defect occurrence display portion 113C in “inspection machine No. 1” shows a status in which “defect” occurs frequently from about the time point 01:50 to about the time point 02:10 immediately after the above-described time period B. In this case, the cause is considered as that the restoration from the abnormality in packaging machine No. 1 does not go well, or that it takes a long time for the operation to stabilize. The cause can be ascertained by referring to the image by manipulating the mark displayed on the image presence/absence display portion 114C in “inspection machine No. 1”.

In addition, when the operating display on all machines at 02:00 is, for example, in the production plan for a production line, and a product type change on the production line is scheduled at this time, the time taken to change the product type can be ascertained. Specifically, it is understood that the running status display portions 111A and 111B first show that “weighing scale No. 1” and “packaging machine No. 1”, which have been “running” until about the time point 02:30, are “operating” for product type change work, and next, the running status display portions 111C and 111D show that “inspection machine No. 1” and “caser No. 1” become “operating” from about the time point 02:40 to about the time point 03:00.

In addition, regarding the display of “operating” near the time point 04:00 on the running status display portion 111B for “packaging machine No. 1”, it can be estimated that a stop for a short period (unscheduled short-time breakdown) has occurred as a result of a warning being ignored from the display of “warning” of the abnormal state. Specifically, it can be ascertained that “packaging machine No. 1” is “running” even though “packaging machine No. 1” is “warning” from about the time point 03:40, but running is temporarily stopped at about the time point 04:00 in order to deal with “warning”. Although more information cannot be ascertained from the display data 100 as illustrated in FIG. 2, it can be referred by accessing the server device 30 by manipulating the client device 31 or 32.

In addition, for example, when “weighing scale No. 1” is the weighing scale 11, “packaging machine No. 1” is the packaging machine 13, and “inspection machine No. 1” is the weight sorting machine 17, and an abnormality does not occur in the weighing scale 11 even though there are many weight defects in the weight sorting machine 17 in “running”, it can be estimated that an abnormality has occurred in the weighing scale 11 or the packaging machine 13 by comparison with weight information of the raw material discharged from the weighing scale 11.

For example, when “inspection machine No. 1” is the X-ray inspection machine 19, if there are many packaging defects such as jamming between the packaged product and the packaging material, the X-ray inspection machine 19, it can be estimated that there is an abnormality in the weighing scale 11 or the packaging machine 13 even if no abnormality occurs in the packaging machine 13.

That is, even the event data that is not reflected in the display data 100 as illustrated in FIG. 2 can be displayed by accessing the server device 30 from the client devices 31 and 32 via the network 40. Therefore, it is not necessary to actually manipulate the target device going to the production line. For example, if it is found that a new analysis is possible by displaying event data of a certain device that has not been reflected in the display data 100 as a new device state such as an abnormality or warning, the event data by updating the event definition file of the server device 30 to include the event data in the display data 100, it is possible to more reliably ascertain the cause of a production delay on the production line by effectively utilizing past event data.

In the present embodiment, the case where the client devices 31 and 32 are connected to the local network 40 has been described, but the client devices 31 and 32 may access the server device 30 via the Internet or the like, and display may be able to be performed. In this manner, it is possible to use, as a reference, the running status of the production line remotely.

As described above, in the above-described embodiment, the server device 30 displays the running status and the abnormal state of each device on the production line in chronological order by arranging the devices in the order of a product flow on the production line.

This makes it possible to check the running status and the abnormal state of each device on the production line in a list, and to easily determine the cause of an error occurring on the production line, such as a case where the device can be operated, but the product is not flowing.

Further, the server device 30 displays the occurrence status of a product defect in addition to the running status and the abnormal state.

As a result, it is possible to check the running status and the abnormal state together with the occurrence of the product defect in a list, and to easily determine the cause of the product defect.

In addition, the server device 30 stores the image obtained by capturing the device in association with the event data, when the abnormality is received as the abnormal state of the event data or when a defect is transmitted as the inspection result of the event data.

Thus, it is possible to check images of the device when an abnormality has occurred or a product defect has occurred, and to easily determine the cause of an error occurring on the production line.

Further, the server device 30 displays the presence or absence of the image of the device in addition to the running status, the abnormal state, and the occurrence status of a product defect.

Thus, it is possible to check the presence or absence of the image of the device together with the running status, the abnormal state, and the occurrence status of the product defect in a list. It is possible to easily check the presence or absence of the image related to an error occurring on the production line. In addition, it is possible to check the image when there is the image, and easily determine the cause of the error occurring on the production line.

Hitherto, the embodiment of the present invention has been disclosed, but it is clear that changes can be made by those skilled in the art without departing from the scope of the present invention. All such modifications and equivalents are intended to be included in the claims as follows.

### DESCRIPTION OF REFERENCE NUMERALS AND SIGNS

1 Production Management System
11 Weighing Scale (Production Line Device)
12 Filling Machine (Production Line Device)
13 Packaging Machine (Production Line Device)
14 Printing Machine (Production Line Device)
15 Printing Inspection Machine (Production Line Device)
16 Appearance Inspection Machine (Production Line Device)
17 Weight Sorting Machine (Production Line Device)
18 Metal Detector (Production Line Device)
19 X-Ray Inspection Machine (Production Line Device)
20 Caser (Production Line Device)
30 Server Device
100 Display Data
101 (101A, 101B, 101C, 101D) Device Display Portion
111 (111A, 111B, 111C, 111D) Running Status Display Portion
112 (112A, 112B, 112C, 112D) Abnormal State Display Portion
113 (113A, 113B, 113C, 113D) Defect Occurrence Display Portion
4 (114A, 114B, 114C, 114D) Image Presence/Absence Display Portion
115 Legend Data

What is claimed is:

1. A production management system that manages a production line including two or more production line devices, the system comprising:
a server device configured to be able to communicate with the production line devices,
wherein the production line device transmits event data including a running status and information regarding an abnormal state to the server device, the event data being set in advance, and
the server device
displays the running status and the abnormal state of each of the production line devices in a chronological order based on the received event data, and
displays the display which is displayed in the chronological order for each of the production line devices, in a direction intersecting a direction along the chronological order, in an order of arranging the production line devices on the production line.

2. The production management system according to claim 1, wherein
the server device further displays an occurrence status of a product defect in addition to the running status and the abnormal state.

3. The production management system according to claim 1, further comprising:
an image capturing unit that captures an image of a vicinity of the production line devices and transmits the captured image to the server device,
wherein the server device
stores the image obtained by capturing the vicinity of the production line devices,
cuts out an image of one of the production line devices transmission source for a predetermined acquisition time before and after an event occurrence time point, when receiving the event data set in advance, and
stores the cut-out image in association with the received event data.

4. The production management system according to claim 2, further comprising:
an image capturing unit that captures an image of a vicinity of the production line devices and transmits the captured image to the server device,
wherein the server device
stores the image obtained by capturing the vicinity of the production line devices,
cuts out an image of one of the production line devices as a transmission source for a predetermined acquisition time before and after an event occurrence time point, when receiving the event data set in advance, and
stores the cut-out image in association with the received event data.

5. The production management system according to claim 3, wherein
the server device further displays presence or absence of the image of the production line devices in addition to the running status and the abnormal state.

6. The production management system according to claim 4, wherein
the server device further displays presence or absence of the image of the production line devices in addition to the running status and the abnormal state.

7. A non-transitory storage medium storing a production management program of a production management system that including a production line including two or more production line devices and a server device configured to be able to communicate with the production line devices, in which the production line device transmits event data set in advance to the server device, the event data being information regarding a running status and an abnormal state, the production management program causing the server device to realize:
a function of displaying the running status and the abnormal state of each of the production line devices in a chronological order based on the received event data, and displaying the display which is displayed in the chronological order for each of the production line devices, in a direction intersecting a direction along the chronological order, in an order of arranging the production line devices on the production line.

8. The non-transitory storage medium storing a production management program according to claim 7, wherein
the server device further displays an occurrence status of a product defect in addition to the running status and the abnormal state.

9. The non-transitory storage medium storing a production management program according to claim 7, wherein
the production management system further includes an image capturing unit that captures an image of a vicinity of the production line devices and transmits the captured image to the server device,
the server device
stores the image obtained by capturing the vicinity of the production line devices,
cuts out an image of one of the production line devices as a transmission source for a predetermined acquisition time before and after an event occurrence time point, when receiving the event data set in advance, and
stores the cut-out image in association with the received event data, and
the server device further displays presence or absence of the image of the production line devices in addition to the running status and the abnormal state.
